(19) United States
(12) Patent Application Publication
(10) Pub. No.: US 2026/0348418 A1
(43) Pub. Date: Nov. 5, 2026

(54) Flow-Hole-Forming Screw, Arrangement Having a Flow-Hole-Forming Screw, and Method for Connecting At Least Two Workpieces

(71) Applicant: Armold Umfortechnik GmbH & Co. KG, Forchtenberg-Emsbach (DE)

(72) Inventors: Nadine Schmetzer, Michelfeld (DE); Heiko Miller, Pfedelbach (DE); Oliver Quirin, Stuttgart (DE); Tobias Hein, Kempten (DE)

(21) Appl. No.: 19/486,262

(22) PCT Filed: Dec. 6, 2024
(86) PCT No.: PCT/EP2024/084996

§ 371 Date: Nov. 20, 2025

(30) Foreign Application Priority Data
Dec. 11, 2023 (DE) 10 2023 134 650.4

(51) Int. Cl. F16B 25/00; F16B 25/10

(52) U.S. Cl. CPC F16B 25/0084; F16B 25/106

(57) ABSTRACT

A flow-hole-forming screw having a shank and a screw head with a drive formation is provided where the shank is provided partially with a tapping thread and with a thread-free hole-forming tip, the hole-forming tip at least partially has a polygonal cross section, the polygonal cross section has a plurality of convex first peripheral portions with a large radius of curvature and a plurality of convex second peripheral portions with a small radius of curvature. In each case one second peripheral portion with a small radius of curvature is arranged between two first peripheral portions with a large radius of curvature, where a cross-sectional enlargement of the tip, starting from the free end of the tip, is greater in a first region of the length, which extends from the free end of the tip as far as 0.2 to 0.4 times the length than over the remaining course of the tip as far as the tapping thread.

### FIELD OF THE INVENTION

The invention relates to a flow-hole-forming screw, to an arrangement having a flow-hole-forming screw, and to a method for connecting at least two workpieces.

### BACKGROUND

Flow-hole-forming screws are used in order to connect together a plurality of components, at least one of which has not been pre-drilled, for example two metal sheets. The flow-hole-forming screw is placed with its tip on one of the workpieces, pressed on, and set in rotation. The two workpieces are heated by the frictional heat that arises, and the tip of the flow-hole-forming screw penetrates into the two workpieces and forms a through-opening in the two workpieces as a result. The flow-hole-forming screw is provided with a tapping thread, such that the screw taps a thread in the very through-opening created by means of the hole-forming tip. The connection of high-strength and/or thick workpieces by means of flow-hole-forming screws places significant demands on the design of the flow-hole-forming screws.

By means of the invention, a flow-hole-forming screw, an arrangement having a flow-hole-forming screw, and a method for connecting at least two workpieces are intended to be improved.

### SUMMARY

The problem addressed by the invention is solved by a flow-hole-forming screw having the features of claim 1, an arrangement having the features of claim 19, and a method for connecting two workpieces having the features of claim 20. Advantageous developments of the invention are specified in the respective dependent claims.

A flow-hole-forming screw according to the invention has a shank and a screw head with a drive formation, wherein the shank is provided partially with a tapping thread and with a thread-free hole-forming tip. The hole-forming tip at least partially has a polygonal cross section, wherein the polygonal cross section has a plurality of convex first peripheral portions with a large radius of curvature and a plurality of convex second peripheral portions with a small radius of curvature. In each case one second peripheral portion with a small radius of curvature is arranged between two first peripheral portions with a large radius of curvature. The peripheral portions are designed and transition into one another such that there is no edge arranged between the first peripheral portions and the second peripheral portions. In particular, the first peripheral portions and the second peripheral portions transition into one another tangentially. A cross-sectional enlargement of the tip is greater in a first region of the length, which extends from the free end of the tip as far as 0.2 to 0.4 times the length, in particular as far as one third of the length, than over the remaining course of the tip as far as the tapping thread. Accordingly, starting from the free end of the tip, a cross-sectional enlargement of the hole-forming tip is initially large and then decreases in size as far as the end of the hole-forming tip. It has been found that with such a design of the hole-forming tip, even very thick workpieces can be connected together reliably by means of the hole-forming screw. The so-called K dimension, defined by a difference between the diameters of a circumscribed circle and an inscribed circle of the polygonal cross section, can remain constant or change along the length of the hole-forming tip.

In a development of the invention, a cross sectional enlargement of the tip is greater in a second region of the length of the tip, which adjoins the first region and extends as far as 0.4 to 0.7 times the length of the tip, in particular takes up a second third of the length of the tip, than a cross-sectional enlargement in a third region of the length of the tip, which adjoins the second region and extends as far as the start of the tapping thread, in particular takes up a third third of the length of the tip.

The external contour of the hole-forming tip becomes accordingly flatter as seen from the free end toward the tapping thread. In this way, even thick workpiece pairings can be reliably penetrated with the hole-forming tip.

In a development of the invention, a difference between the diameters of a circumscribed circle and an inscribed circle of the polygonal cross section changes along the length of the hole-forming tip.

By means of such a change in the so-called K dimension, the penetration properties of the hole-forming tip can be influenced. In particular, a contact area between the tip and workpiece upon placement, rotation and hole-forming can be influenced in order to ensure reliable hole-forming and penetration of the workpieces.

In a development of the invention, the difference between the diameters of the circumscribed circle and the inscribed circle of the polygonal cross section is greater than zero, in particular greater than 0.1 mm, as seen along the entire length of the hole-forming tip.

Specifically in the case of workpiece pairings with a large thickness and a long hole-forming tip of the flow-hole-forming screw, a polygonal design of the cross section of the hole-forming tip along the entire length thereof is extremely advantageous. The difference between the diameters of the circumscribed circle and the inscribed circle of the polygonal cross section (K dimension) may be constant along the entire length of the hole-forming tip.

In a development of the invention, the difference between the diameters of the circumscribed circle and the inscribed circle of the polygonal cross section (K dimension) initially increases starting from the free end of the hole-forming tip and then decreases again as far as the transition into the tapping thread.

In a development of the invention, the difference between the diameters of the circumscribed circle and the inscribed circle of the polygonal cross section (K dimension) increases starting from the free end of the hole-forming tip in the first region of the length of the hole-forming tip and drops again as far as the transition into the tapping thread.

It has been found that an increase in the so-called K dimension approximately as far as the first third of the length is advantageous for reliable and process-reliable formation of the through-opening by means of the hole-forming tip.

In a development of the invention, the difference between the diameters of the circumscribed circle and the inscribed circle of the polygonal cross section (K dimension) increases starting from the free end of the hole-forming tip from the initial value to 2 to 3 times the initial value, wherein, in particular, the initial value is measured starting from the free end of the tip at 1/20 to 1/10 of the length of the hole-forming tip.

Such a clear increase in the initial value to 2 to 3 times the initial value allows a formation of the through-opening that is reliable and process-reliable to carry out by means of the hole-forming tip. In particular when the free end of the tip is rounded, the initial value is measured at 1/20 to 1/10 of the length of the hole-forming tip, i.e. after the end of the rounding of the tip.

In a development of the invention, the initial value of the difference between the diameters of the circumscribed circle and the inscribed circle of the polygonal cross section (K dimension) lies between 0.1 mm and 0.2 mm, in particular between 0.1 mm and 0.15 mm.

In a development of the invention, the difference between the diameters of the circumscribed circle and the inscribed circle of the polygonal cross section (K dimension) initially increases, starting from the free end of the hole-forming tip, and then decreases again, as far as the transition into the tapping thread, to the initial value at the free end of the tip, in particular at 1/20 to 1/10 of the length of the tip, or decreases to 1.6 to 1.3 times the initial value.

In a development of the invention, as seen along the length of the hole-forming tip, an angular position of the first peripheral portions and of the second peripheral portions changes about a longitudinal center axis of the shank.

In particular, the polygonal cross section exhibits a twist as seen along the length of the hole-forming tip. The provision of a twist in the polygonal cross section at the hole-forming tip makes the reliable and process-reliable formation of the through-opening by means of the hole-forming tip easier. The twist brings about a force reduction during hole-forming. The hole can thus be drilled with less force or the duration of hole-forming can be reduced when the same force is applied.

In a development of the invention, the angular position of the first peripheral portions and of the second peripheral portions changes, as seen along the entire length of the tip, between 0° and 50°, in particular between 20° and 45°.

In a development of the invention, the angular position of the first peripheral portions and of the second peripheral portions changes more greatly in the first region of the length of the hole-forming tip than in the second region and the third region of the length of the tip, wherein the second region adjoins the first region and the third region extends from the end of the second region as far as the transition into the tapping thread. Along the entire length of the tip there may be a twist. The twist may change along the entire length of the tip.

A greater twist of the polygonal cross section in a length region that adjoins the free end of the tip makes it easier for the workpieces to be penetrated and can ensure a reliable and process-reliable formation of the through-opening by means of the hole-forming tip as a result.

In a development of the invention, the angular position f the first peripheral portions and of the second peripheral portions changes, in the first region of the length of the tip, by between 0° and 50°, in particular between 20° and 45°. In a development of the invention, a radius of curvature at the free end of the lies between 0.4 mm and 0.6 mm.

In a development of the invention, a length of the hole-forming tip amounts to 40% to 60%, in particular 50%, of the length of the screw shank.

In a development of the invention, the screw is made from an alloyed or unalloyed tool steel.

The high material requirements placed on the flow-hole-forming screw can be met by a tool steel. The tool steel may be unalloyed, for example a C steel, in particular C62 steel, or alloyed, for example a chromium-vanadium steel.

In a development of the invention, the tool steel has been hardened.

In the context of the invention, only a portion of the flow-hole-forming screw, for example only the flow-hole-forming tip, may have been hardened. Different portions of the screw may have different hardnesses.

In a development of the invention, the screw is provided with an anticorrosion coating and a seal.

For example, the flow-hole-forming screw is coated with a ZnNi coating for corrosion protection and additionally coated with an organic transparent coating for the seal. A seal may positively influence thread forming.

The problem addressed by the invention is also solved by an arrangement having a flow-hole-forming screw according to the invention and at least two workpieces which have been connected together by means of the flow-hole-forming screw, wherein a length of the tip is greater than or equal to a length of a through-opening produced by means of the screw in the two workpieces.

In this way, the through-opening can initially be formed by means of the hole-forming tip and only then does the tapping thread engage in the produced through-opening. As a result, the tapping thread can be reliably formed, since a feed rate of the flow-hole-forming screw differs between the formation of the through-opening by means of the hole-forming tip and the tapping of a thread. The length of the through-opening is understood to be the length, produced in the entire compound structure, of the through-opening, with which the screw tip is in contact, i.e., in particular, the thickness of the components to be connected and the length of a pull-through that arises during hole-forming.

The problem addressed by the invention is also solved by a method for connecting at least two workpieces by means of a flow-hole-forming screw according to the invention, wherein the production of a through-opening by means of the hole-forming tip of the screw is provided and, following the production of the through-opening, the tapping of a thread in the through-opening by means of the tapping thread of the screw is provided.

Further features and advantages of the invention will become apparent from the claims and the following description of a preferred embodiment of the invention in conjunction with the drawings.

### BRIEF DESCRIPTION OF THE DRAWINGS

In the drawings:

FIG. 1 shows a side view of a flow-hole-forming screw according to the invention,

FIG. 2 shows a plan view of the flow-hole-forming screw

FIG. 3 shows a schematic view, in partial section, of an arrangement having the flow-hole-forming screw in FIG. 1 and two workpieces,

FIG. 4 shows a side view, in partial section, of the screw in FIG. 1,

FIG. 5 shows an illustration of the percentage cross-sectional enlargement of the hole-forming tip of the screw in FIG. 1,

FIG. 6 shows two schematic views of the hole-forming tip of the screw in FIG. 1, revealing the twist, and

FIG. 7 shows an illustration of the K dimension of the polygonal cross section of the hole-forming tip of the screw in FIG. 1 as seen along the length of the hole-forming tip.

### DETAILED DESCRIPTION

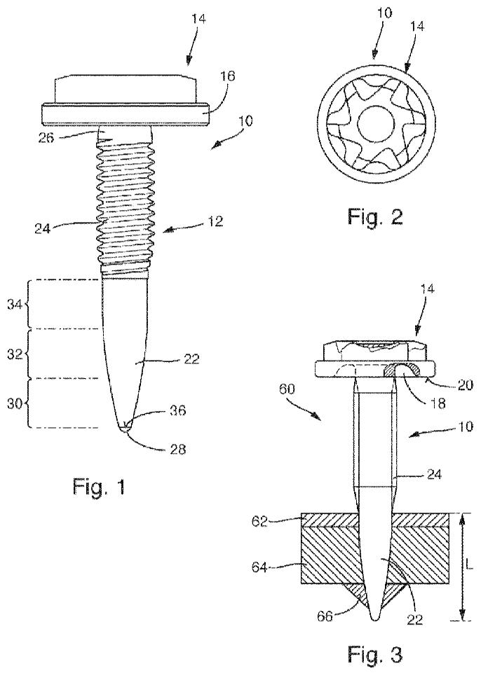

FIG. 1 shows a hole-forming screw 10 according to the invention, which has a shank 12 and a screw head 14. The screw head 14 is provided with a drive formation, which is more clearly apparent in the plan view in FIG. 2. By means of the drive formation, the screw 10 can be set in rotation.

In addition to the drive formation, the screw head 14 is provided with a cylindrical portion 16, in which, cf. FIG. 3, a peripheral groove 18 is formed. Following complete screwing of the screw 10 into a workpiece or two workpieces, the groove 18 receives material that may have risen up from the top side of the workpieces during the formation of a through-opening in the workpieces and during the tapping of a tapping thread, such that an annular portion 20, located outside the groove 18, of the underside of the screw head 14 can rest flat on the top side of a workpiece.

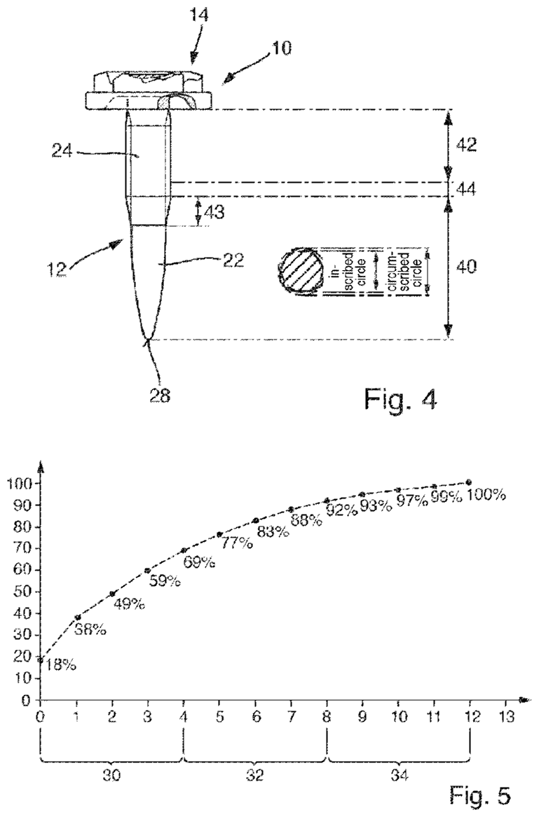

Starting from its free end, the screw shank 12 is provided with a hole-forming tip 22. The hole-forming tip 22 has a polygonal cross section, which has a plurality of first peripheral portions with a small convex curvature and a large radius of curvature and a plurality of second peripheral portions with a large convex curvature and a small radius of curvature, wherein in each case one second peripheral portion with a large curvature and a small radius of curvature is arranged between two first peripheral portions with a small curvature and a large radius of curvature. Transitions between the individual peripheral portions are rounded, such that an edge does not arise at the transition between in each case a first peripheral portion and a second peripheral portion. The polygonal cross section of the hole-forming tip 22 is indicated schematically in FIG. 4. The polygonal cross section has a circumscribed circle and an inscribed circle. A difference between the circumscribed circle and the inscribed circle defines the so-called K dimension, which forms a dimension for the deviation of the polygonal cross section from a circular shape. The hole-forming tip 22 is followed by a tapping thread 24. Starting from the end of the hole-forming tip 22, the tapping thread 24 initially has an increasing outside diameter. Over the remaining course of the tapping thread 24, this then has a constant outside diameter.

Between the end of the tapping thread 24 and the underside of the screw head 14 there is still a short, thread-free portion 26, which is also referred to as a thread run-out underhead.

It is apparent from FIG. 1 that a cross-sectional enlargement starting from the free end 28 of the hole-forming tip 22 as far as the tapping thread 24 is not uniform but decreases with increasing distance from the free end 28 of the hole-forming tip 22. In particular, it is apparent that the free end 28 of the hole-forming tip 22 is rounded. In a first region 30 of the length of the hole-forming tip 22, wherein the first region 30 corresponds to a first third of the length of the tip 22 in the embodiment illustrated, a cross-sectional enlargement is clearly greater than over the remaining course of the hole-forming tip 22. In a second region 32 of the length of the hole-forming tip 22, corresponding to a second third of the length in FIG. 1, the cross-sectional enlargement is less than in the first region 30, but still greater than in a third region 34 of the length of the hole-forming tip 22, corresponding to a third third of the length in FIG. 1.

The percentage enlargement in the cross section of the hole-forming tip 22 is plotted in FIG. 5. An initial value is, in contrast to the illustration in FIG. 5, not measured at 0 mm, i.e. not at the free end 28 of the hole-forming tip 22, but at approximately 1/10 to 1/20 of the length of the hole-forming tip. In FIG. 1, a line 36 is drawn which lies at approximately 1/20 of the length of the hole-forming tip 22, wherein the line 36 represents an imaginary line and serves for measuring the initial value of a percentage cross-sectional enlargement. In the first region 30, i.e. from 0 mm to 4 mm in the illustration in FIG. 5, the cross section enlarges significantly and lies, at 4 mm, at 69% of the final cross section at the end of the hole-forming tip 22 at 12 mm. Starting from the initial value of 18%, the cross section thus enlarges to 51% in the first region 30.

In the second region 32, the cross section enlarges in terms of percentage from 69% to 92% of the final cross section at 12 mm at the end of the hole-forming tip 22. A cross-sectional enlargement in the second region 32 consequently lies at 23% and is thus much less than in the first region 30.

In the third region 34, the cross section of the hole-forming tip 22 enlarges from 92% to the final value of 100%. Over the course of the third region 34, the cross section of the hole-forming tip 22 consequently enlarges only by 8%, i.e. much less than in the second region 32 and considerably less than in the first region 30.

It is also apparent from FIG. 5 and FIG. 1 that the cross section of the hole-forming tip 22 increases along the entire length of the hole-forming tip 22 as far as the transition into the tapping thread 24, i.e. in the first region 30, in the second region 32, and in the third region 34. The hole-forming tip 22 consequently does not have a cylindrical portion.

In the embodiment illustrated, the different regions 30, 32, 34 of the hole-forming tip 32 each have a length which corresponds to one third of the length of the hole-forming tip 22. However, in the context of the invention, the length of the regions 30, 32, 34 can also lie between 0.2 and 0.4 times the length of the tip, and in particular, the regions 30, 32, 34 may also have different lengths.

FIG. 4 shows a side view of the screw 10 in FIG. 1. Indicated in FIG. 4 is a first length portion 40 of the shank 12 of the hole-forming screw 10, which extends, starting from the free end 28 of the shank, into the tapping thread 24. In this region 40, the shank 12 has a polygonal cross section. As has already been mentioned, the polygonal cross section has an inscribed circle and a circumscribed circle, wherein a difference between the circumscribed circle and the inscribed circle determines the so-called K dimension of the shank 12. By contrast, in a further portion 42, which extends along a part of the tapping thread 24 as far as the underside of the screw head 14, the cross section of the shank 12 is circular. Between the first portion 40 and the second portion 42 there is a transitional portion 44, in which the cross section of the shank 12 transitions from the polygonal cross section in the region 40 to the circular cross section of the region 42. The transitional region 44 lies in the region of the tapping thread 24. A tapping portion 43 lies partially in the region 40 and partially in the transitional portion 44. In the tapping portion 43, an outside diameter of the tapping thread 24 increases. The flank height of the tapping thread 24 increases in the tapping portion 43 from zero to the maximum final value. The tapping portion 24 performs a majority of the material deformation on tapping a thread into one or more components.

In the context of the invention, the difference between the circumscribed circle and the inscribed circle, i.e. the so-called K dimension, changes along the length of the hole-forming tip 22.

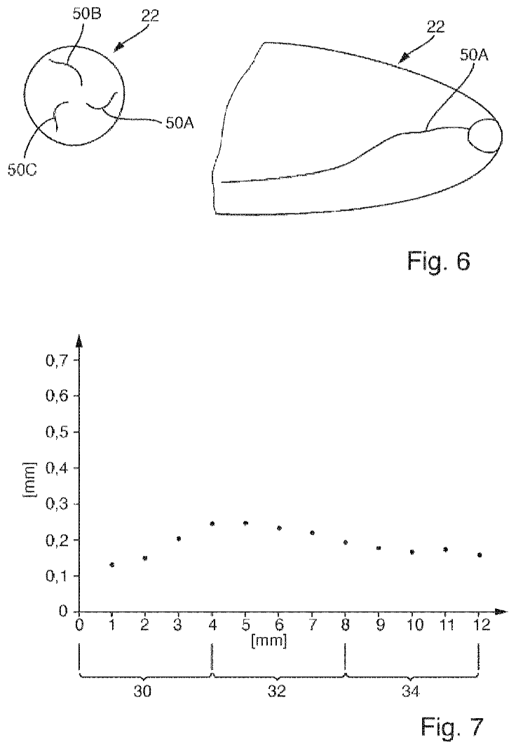

Furthermore, an angular position of the first peripheral portions with a small convex curvature and a large radius of curvature and of the second peripheral portions with a large convex curvature and a small radius of curvature changes as seen along a length of the hole-forming tip 22. In the case of the screw according to FIG. 1, this results in a twist in the region of the hole-forming tip 22. The two schematic illustrations of the hole-forming tip 22 in FIG. 6 illustrate the twist in the region of the hole-forming tip 22. The two illustrations in FIG. 6 are respectively formed by sections, taken alongside one another at a small spacing, through the shank 12. The continuous lines 50A, 50B, 50C in FIG. 6 each mark the center of a respective second peripheral portion with a large convex curvature and a small radius of curvature. It is apparent that an angular position of the first peripheral portions and of the second peripheral portions about a longitudinal center axis of the shank 12 changes along the hole-forming tip 22, in accordance with a twist of the polygonal cross section. It is furthermore apparent from FIG. 6 that this angular position of the first peripheral portions and of the second peripheral portions does not change linearly, but irregularly as seen along the length of the hole-forming tip 22. It is apparent from the upper illustration in FIG. 6 that the angular position initially changes significantly and a change in the angular position then becomes smaller. In other words, the hole-forming tip 22 has a more significant twist in a first length region than in a second length region that adjoins the first length region and extends as far as the screw-head end of the tip.

FIG. 7 shows a diagram from which the so-called K dimension is apparent. A change in the angular position of the first peripheral portions and of the second peripheral portions about a longitudinal center axis of the shank is likewise apparent, since, in the illustrated embodiment, the twist, in other words an angular position of the first peripheral portions and of the second peripheral portions, changes concurrently with the so-called K dimension, i.e. the difference between the circumscribed circle and the inscribed circle of the polygonal cross section. In other words, the twist is significant in a region in which the K dimension is also large.

It is apparent from FIG. 7 that the K dimension changes in the first region 30 of the length of the hole-forming tip 22, i.e. from 0 to 4 mm in the embodiment illustrated, such that the K dimension increases significantly. In the embodiment. illustrated, the K dimension increases from a value of 0.1 mm to a value of approximately 0.25 mm at the end of the first region 30.

In the second region 32 of the length of the hole-forming tip 22, the K dimension drops again already, from a value of approximately 0.25 mm to a value of approximately 0.2 mm in the embodiment illustrated. In the third region 34 of the length of the hole-forming tip 22, the K dimension drops further, but less significantly than in the second region 32. In the embodiment illustrated, the K dimension drops in the third region 34 from a value of 0.2 mm to approximately 0.15 mm.

It is apparent from FIG. 7 that the K dimension does not drop to the initial value at the start of the hole-forming tip 22. Furthermore, it is apparent that the K dimension does not drop to zero along the entire length of the hole-forming tip 22; in other words, the hole-forming dip 22 thus has a polygonal cross section along its entire length.

As has already been mentioned, a twist of the hole-forming tip 22 in the first region 30 is greater than in the second region 32 and in the third region 34. In the second region 32, the twist is still somewhat greater than in the third region 34.

In other words, in the first region 30, as seen over the length of the hole-forming tip 22, an angular position of the first peripheral portions and of the second peripheral portions about a longitudinal center axis of the shank changes more greatly per length unit than in the second region 32 and in the third region 34.

In the second region 32, an angular position of the first peripheral portions and of the second peripheral portions about a longitudinal center axis of the shank still changes more greatly per length unit than in the third region 34.

As has already been mentioned, in the embodiment illustrated, a length of the regions 30, 32, 34 amounts in each case to one third of the length of the hole-forming tip 22. In the context of the invention, a length of the regions 30, 32, 34 may lie between 0.2 times and 0.4 times the length of the hole-forming tip 22. In particular, the regions 30, 32, 34 may also have different lengths.

FIG. 3 shows an arrangement 60 according to the invention having a screw 10 according to the invention and two workpieces 62, 64 which are intended to be connected by the screw 10 according to the invention.

It is apparent from FIG. 3 that a length of the hole-forming tip 22 is greater than the sum of the thicknesses of the two workpieces 62, 64. The length of the hole-forming tip 22 is even greater than the sum of the thicknesses of the workpieces 62, 64 and the thickness of a pull-through 66 that is formed, starting from the underside of the second workpiece 64, during the formation of a through-opening through the two workpieces 62, 64 by means of the hole-forming tip 22. The length of the through-opening is understood to be the length, produced in the entire compound structure made up of the components 62, 64 and the pull-through 66, of the through-opening. In the example in FIG. 3, the length of the through-opening is equal to the sum of the thicknesses of the components 62, 64 and the maximum thickness of the pull-through 66. The length of the through-opening is indicated by the letter L in FIG. 3.

The length of the hole-forming tip 22 is thus dimensioned such that. the through-opening in the two workpieces 62, 64 and the forming pull-through 66 has already been fully produced before the start of the tapping thread 24 engages in the through-opening. This is also advantageous because a feed rate differs between the formation of the through-opening by means of the hole-forming tip 22 and the tapping of a thread by means of the tapping thread 24. During the tapping of a thread, the feed rate is set by the pitch of the tapping thread 24, whereas the feed rate during the formation of the through-opening by means of the hole-forming tip 22 depends on the heating up of the two workpieces 62, 64 and the contact pressure of the screw 10.

During the tapping of a thread in the through-opening, i.e. subsequently to the state illustrated in FIG. 3, material is thrown up from the top side of the upper workpiece 62. This thrown-up or upwardly displaced material of the upper workpiece 62 can then be received in the peripheral groove 18 in the underside of the screw head 14. In the finally screwed-together state, the annular region 20 on the underside of the screw head 14 lies on the top side of the workpiece 62 as a result.

1. A flow-hole-forming screw comprising:
a shank and
a screw head with a drive formation,
wherein the shank is provided partially with a tapping thread and with a thread-free hole-forming tip,
wherein the hole-forming tip at least partially has a polygonal cross section,
wherein the polygonal cross section has a plurality of convex first peripheral portions with a large radius of curvature and a plurality of convex second peripheral portions with a small radius of curvature,
wherein in each case one second peripheral portion with a small radius of curvature is arranged between two first peripheral portions with a large radius of curvature,
further wherein a cross-sectional enlargement of the tip, starting from the free end of the tip, is greater in a first region of the length, which extends from the free end of the tip as far as 0.2 to 0.4 times the length, in particular as far as one third of the length, than over the remaining course of the tip as far as the tapping thread.

2. The flow-hole-forming screw as claimed in claim 1, wherein a cross-sectional enlargement of the tip is greater in a second region of the length of the tip, which adjoins the first region and extends as far as 0.4 to 0.7 times the length of the tip, in particular takes up a second third of the length of the tip, than a cross-sectional enlargement in a third region of the length of the tip, which adjoins the second region and extends as far as the start of the tapping thread, in particular takes up a third third of the length of the tip.

3. The flow-hole-forming screw as claimed in claim 1, wherein a difference between the diameters of a circumscribed circle (C dimension) and an inscribed circle (E dimension) of the polygonal cross section (K dimension) changes as seen along the length of the hole-forming tip.

4. The flow-hole-forming screw as claimed in claim 3, wherein the difference between the diameters of the circumscribed circle and the inscribed circle of the polygonal cross section (K dimension) is greater than zero, in particular greater than/equal to 0.1 mm, as seen along the entire length of the hole-forming tip.

5. The flow-hole-forming screw as claimed in claim 3, wherein the difference between the diameters of the circumscribed circle and the inscribed circle of the polygonal cross section (K dimension) initially increases starting from the free end of the hole-forming tip, and then decreases again as far as the transition into the tapping thread.

6. The flow-hole-forming screw as claimed in claim 5, wherein the difference between the diameters of the circumscribed circle and the inscribed circle of the polygonal cross section (K dimension) increases starting from the free end of the hole-forming tip in the first region of the length of the hole-forming tip and drops again as far as the transition into the tapping thread .

7. The flow-hole-forming screw as claimed in claim 5, wherein the difference between the diameters of the circumscribed circle and the inscribed circle of the polygonal cross section (K dimension) increases starting from the free end of the hole-forming tip from the initial value to 2 to 3 times the initial value, wherein, in particular, the initial value is measured starting from the free end of the tip at 1/10 to 1/20 of the length of the hole-forming tip.

8. The flow-hole-forming screw as claimed in claim 7, wherein the initial value of the difference between the diameters of the circumscribed circle and the inscribed circle of the polygonal cross section (K dimension) lies between 0.1 mm and 0.2 mm, in particular between 0.1 mm and 0.15 mm.

9. The flow-hole-forming screw as claimed in claim 1, wherein the difference between the diameters of the circumscribed circle and the inscribed circle of the polygonal cross section (K dimension), starting from the free end of the hole-forming tip, increases in the first region of the length of the hole-forming tip and then decreases again, as far as the transition into the tapping thread, to the initial value at the free end of the tip, in particular at 1/20 to 1/10 of the length of the tip, or decreases to 1.6 to 1.3 times the initial value.

10. The flow-hole-forming screw as claimed in claim 1, wherein, as seen along the length of the hole-forming tip, an angular position of the first peripheral portions and of the second peripheral portions changes about a longitudinal center axis of the shank.

11. The flow-hole-forming screw as claimed in claim 10, wherein the angular position of the first peripheral portions and of the second peripheral portions changes, as seen along the entire length of the tip, between more than 0 degrees and 50 degrees, in particular between 20 degrees and 45 degrees.

12. The flow-hole-forming screw as claimed in claim 10, wherein the angular position of the first peripheral portions and of the second peripheral portions starts, changes more greatly in the first region of the length of the hole-forming tip than in the second region and the third region of the length of the tip, wherein the second region adjoins the first region and the third region extends as far as the transition into the tapping thread.

13. The flow-hole-forming screw as claimed in claim 11, wherein the angular position of the first peripheral portions and of the second peripheral portions changes, in the first region of the length of the tip, by between more than 0 degrees and 50 degrees, in particular between 20 degrees and 45 degrees.

14. The flow-hole-forming screw as claimed in claim 1, wherein a radius of curvature of the free end of the tip lies between 0.4 mm and 0.6 mm.

15. The flow-hole-forming screw as claimed in claim 1, wherein a length of the hole-forming tip amounts to 40% to 60%, in particular 50%, of the length of the screw shank.

16. The flow-hole-forming screw as claimed in claim 1, wherein the screw is made from an alloyed or unalloyed tool steel.

17. The flow-hole-forming screw as claimed in claim 16, wherein the tool steel has been hardened.

18. The flow-hole-forming screw as claimed in claim 16, wherein the screw (10) is provided with an anticorrosion coating and a seal.

19. An arrangement having a flow-hole-forming screw as claimed in claim 1, and at least two workpieces which have been connected together by means of the flow-hole-forming screw, wherein a length of the tip is greater than or equal to a length of a through-opening produced by means of the screw in the two workpieces.

20. A method for connecting at least two workpieces by means of a flow-hole-forming screw as claimed in claim 1, where producing a through-opening by means of the hole-forming tip of the screw and, following the production of the through-opening, tapping a thread in the through-opening by means of the tapping thread of the screw.
